(19) United States
(12) Patent Application Publication
(10) Pub. No.: US 2026/0355697 A1
(43) Pub. Date: Nov. 12, 2026

(54) Gas Separation Membrane And Method For Producing Gas Separation Membrane

(71) Applicant: SEIKO EPSON CORPORATION, Tokyo (JP)

(72) Inventor: Takuya MIYAKAWA, Matsumoto (JP)

(21) Appl. No.: 19/570,801

(22) Filed: Mar. 18, 2026

(30) Foreign Application Priority Data
Mar. 19, 2025 (JP) 2025-044186

(51) Int. Cl. B01D 69/12; B01D 67/00; B01D 71/24

(52) U.S. Cl. CPC B01D 69/1213; B01D 67/0088; B01D 71/24; B01D 2323/226; B01D 2323/34; B01D 2323/64

(57) ABSTRACT

A gas separation membrane for separating a predetermined component from a mixed gas by allowing the predetermined component to permeate therethrough, includes: a porous layer that is porous; a separation layer made of an organopolysiloxane; and an adhesive layer provided between the porous layer and the separation layer and adhering the porous layer and the separation layer, in which the adhesive layer is made of a thermoplastic resin.

The present application is based on, and claims priority from JP Application Serial Number 2025-044186, filed Mar. 19, 2025, the disclosure of which is hereby incorporated by reference herein in its entirety.

### BACKGROUND

### 1. Technical Field

The present disclosure relates to a gas separation membrane and a method for producing a gas separation membrane.

### 2. Related Art

In order to implement carbon neutrality or carbon minus, a technique is being considered to capture and collect carbon dioxide discharged from thermal power plants, boiler facilities, or the like, and carbon dioxide in the atmosphere. As this technique, there has been a membrane separation method for separating carbon dioxide using a gas separation membrane.

For example, JP-A-2024-042578 discloses a gas separation membrane including a porous layer, a first resin layer provided at a surface on one side of the porous layer and made of an organopolysiloxane, and a second resin layer provided at a surface of the first resin layer on a side opposite to that of the porous layer and made of the organopolysiloxane. In the gas separation membrane, the first resin layer has porosity greater than that of the second resin layer, and the second resin layer is chemically bonded to the first resin layer.

JP-A-2024-042578 discloses that a pressure difference is provided between upstream and downstream of the gas separation membrane to allow a specific gas component from a mixed gas to permeate the gas separation membrane.

According to such a configuration, it is possible to achieve a gas separation membrane having high mechanical strength and a high transmission rate of a target gas.

JP-A-2024-042578 is an example of the related art.

In the gas separation membrane described in JP-A-2024-042578, adhesion between the first resin layer and the porous layer is low. Therefore, when the pressure difference is provided between upstream and downstream of the gas separation membrane, peeling or the like may occur at an interface between the first resin layer and the porous layer.

Therefore, it is an object to enhance adhesion between the resin layer (separation layer) and the porous layer and to reduce occurrence of damage such as peeling between layers of the gas separation membrane.

### SUMMARY

A gas separation membrane according to an application example of the present disclosure is a gas separation membrane for separating a predetermined component from a mixed gas by allowing the predetermined component to permeate therethrough, and the gas separation membrane includes: a porous layer that is porous; a separation layer made of an organopolysiloxane; and an adhesive layer provided between the porous layer and the separation layer and adhering the porous layer and the separation layer, in which the adhesive layer is made of a thermoplastic resin.

A method for producing a gas separation membrane according to an application example of the present disclosure includes: a separation layer forming step of forming a separation layer made of an organopolysiloxane at one surface of a sacrificial layer; an adhesive layer forming step of forming an adhesive layer at one surface of the porous layer; an adhering step of adhering the porous layer and the separation layer via the adhesive layer; and a sacrificial layer removing step of removing the sacrificial layer, in which the adhesive layer is made of a thermoplastic resin, and in the adhering step, the porous layer and the separation layer adhere to each other by thermal fusion of the adhesive layer.

### BRIEF DESCRIPTION OF THE DRAWINGS

FIG. 1 is a cross-sectional view schematically illustrating a gas separation membrane according to an embodiment.

FIG. 2 is a schematic view illustrating a method for measuring an average pore diameter in an observation image of a cross section of a porous layer.

FIG. 3 is a schematic view illustrating a method for measuring an aperture rate in the observation image of the cross section of the porous layer.

FIG. 4 is a cross-sectional view illustrating a gas separation membrane according to a modification of the embodiment.

FIG. 5 is a process chart illustrating a method for producing the gas separation membrane illustrated in FIGS. 1 and 4 (a method for producing the gas separation membrane according to the embodiment).

FIG. 6 is a cross-sectional view illustrating the method for producing the gas separation membrane illustrated in FIG. 5.

FIG. 7 is a cross-sectional view illustrating the method for producing the gas separation membrane illustrated in FIG. 5.

FIG. 8 is a cross-sectional view illustrating the method for producing the gas separation membrane illustrated in FIG. 5.

FIG. 9 is a cross-sectional view illustrating the method for producing the gas separation membrane illustrated in FIG. 5.

FIG. 10 is a cross-sectional view illustrating the method for producing the gas separation membrane illustrated in FIG. 5.

FIG. 11 is a cross-sectional view illustrating the method for producing the gas separation membrane illustrated in FIG. 5.

FIG. 12 is a cross-sectional view illustrating the method for producing the gas separation membrane illustrated in FIG. 5.

FIG. 13 is a cross-sectional view illustrating the method for producing the gas separation membrane illustrated in FIG. 5.

FIG. 14 is a cross-sectional view illustrating the method for producing the gas separation membrane illustrated in FIG. 5.

FIG. 15 is a cross-sectional view illustrating the method for producing the gas separation membrane illustrated in FIG. 5.

FIG. 16 is Table 1 illustrating compositions of gas separation membranes and evaluation results of the gas separation membranes in Examples.

FIG. 17 is Table 2 illustrating compositions of gas separation membranes and evaluation results of the gas separation membranes in Examples and Comparative Examples.

### DESCRIPTION OF EMBODIMENTS

Hereinafter, a gas separation membrane and a method for producing a gas separation membrane according to the present disclosure will be described in detail based on embodiments shown in the accompanying drawings.

### 1. Overview of Gas Separation Membrane

First, a configuration of the gas separation membrane according to the embodiment will be described.

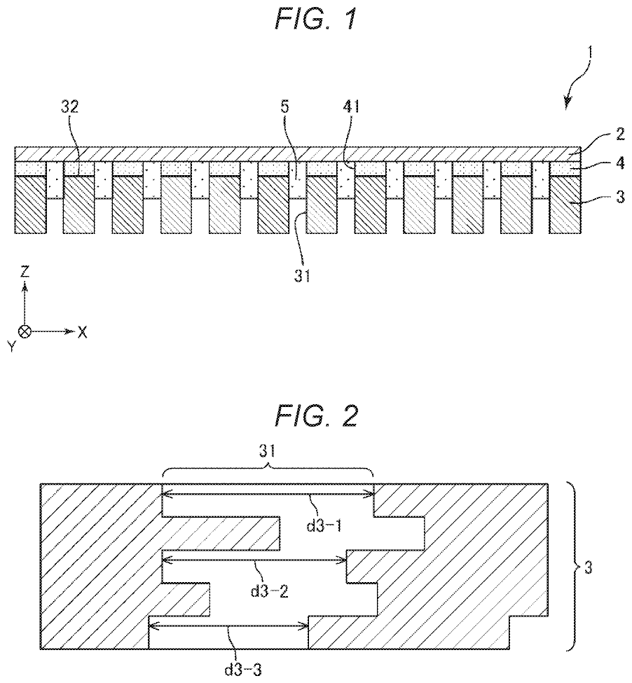

FIG. 1 is a cross-sectional view schematically illustrating a gas separation membrane 1 according to the embodiment. In the present application, an X axis, a Y axis, and a Z axis are set as three axes orthogonal to one another, and are indicated by arrows. A base end of the arrow indicating each axis is defined as “minus” and a tip end is defined as “plus”. A positive side of the Z axis is defined as “upper” and a negative side of the Z axis is defined as “lower”.

A mixed gas containing a predetermined component is supplied to an upstream side of the gas separation membrane 1 (above the gas separation membrane 1) illustrated in FIG. 1. The gas separation membrane 1 separates the predetermined component from the mixed gas by allowing the predetermined component to permeate downstream (below the gas separation membrane 1). Examples of the predetermined component include acidic gases such as carbon dioxide (CO₂), hydrogen sulfide (H₂S), sulfur oxide (SOₓ), and nitrogen oxide (NOₓ), as well as oxygen molecules, water molecules, and radioactive substances. In the following description, a case where the predetermined component is carbon dioxide will be described as an example, but when the gas separation membrane 1 is used for a component other than carbon dioxide, the description in which carbon dioxide described below is replaced with the component can be applied as it is.

The gas separation membrane 1 illustrated in FIG. 1 includes a porous layer 3, a separation layer 2, an adhesive layer 4, and an impregnation layer 5.

The porous layer 3 is porous and has a sheet shape spreading along an X-Y plane.

The separation layer 2 is made of an organopolysiloxane. The separation layer 2 has a gas separation ability that allows carbon dioxide to permeate.

The adhesive layer 4 is provided between the porous layer 3 and the separation layer 2. The adhesive layer 4 is made of a thermoplastic resin and has a function of adhering the porous layer 3 and the separation layer 2.

The impregnation layer 5 penetrates into pores 31 of the porous layer 3. The impregnation layer 5 may have a gas separation ability that allows carbon dioxide to permeate. The impregnation layer 5 may be provided as necessary, or may be omitted.

According to such a configuration, since the adhesive layer 4 is made of a thermoplastic resin, adhesive properties of the thermoplastic resin enable the porous layer 3 and the separation layer 2 to be firmly adhered. Therefore, even when the separation layer 2 is made of the organopolysiloxane and has low surface energy, it is possible to achieve the gas separation membrane 1 capable of reducing damage such as peeling between layers. That is, the gas separation membrane 1 including the separation layer 2 having a good gas separation ability by the organopolysiloxane and having excellent durability can be achieved.

The impregnation layer 5 is impregnated in the pores 31 of the porous layer 3. By providing the impregnation layer 5 in the pores 31 of the porous layer 3, the impregnation layer 5 can be held even when the impregnation layer 5 is made of a substance having an amorphous shape such as a liquid. Accordingly, the gas separation ability of the impregnation layer 5 can be added to the gas separation membrane 1.

### 1.1. Porous Layer

The porous layer 3 has a sheet shape and supports the separation layer 2 from downstream. The porous layer 3 has a higher gas transmission rate than the separation layer 2 and has higher mechanical strength than the separation layer 2. Accordingly, even when the separation layer 2 does not have sufficient mechanical properties, the porous layer 3 supports the separation layer 2, thereby achieving the gas separation membrane 1 having excellent mechanical properties.

The porous layer 3 is made of a porous material. The porous layer 3 has a large number of pores 31 and has good gas permeability.

Examples of a constituent material for the porous layer 3 include an inorganic porous material such as a porous ceramic material and a porous metal material, and an organic porous material such as a porous polymer material. The porous material may be a composite material obtained by combining these materials. Further, the porous layer 3 may be a laminate obtained by laminating layers made of mutually different materials.

The inorganic porous material has excellent weather resistance. Therefore, use of the inorganic porous material enhances durability of the gas separation membrane 1.

The organic porous material is excellent in flexibility and moldability. Therefore, by using the organic porous material, impact resistance of the gas separation membrane 1 can be enhanced, and a degree of freedom in shape can be improved.

Examples of the ceramic material include alumina, cordierite, mullite, silicon carbide, silicon oxide, and zirconia.

Examples of the metal material include stainless steel, a copper alloy, an aluminum alloy, and a titanium alloy.

Examples of the polymer material include polyolefin resins such as polyethylene and polypropylene, fluorine-containing resins such as polytetrafluoroethylene, polyvinyl fluoride and polyvinylidene fluoride, polystyrene, cellulose, cellulose acetate, cellulose nitrate, polycarbonate, polyurethane, polyacrylonitrile, polyphenylene oxide, polysulfone, polyethersulfone, polyimide, polyaramid, nylon, and polysiloxane.

The porous layer 3 may be a filter having an open cell structure. The filter having the open cell structure is also called an absolute-type filter, and includes the pores 31 that are continuous from one surface to the other surface that are in a front-back relationship with each other and are independent from each other.

A thickness of the porous layer 3 is preferably 5 μm or more and 300 μm or less, more preferably 10 μm or more and 200 μm or less, and further preferably 30 μm or more and 100 μm or less. When the thickness is within the above range, the porous layer 3 having good gas permeability and necessary and sufficient mechanical strength can be obtained.

When the thickness of the porous layer 3 falls below the above lower limit value, mechanical strength of the porous layer 3 may be reduced, and breakage or the like may occur. In this case, the separation layer 2 cannot be sufficiently supported by the porous layer 3, and a gas selectivity ratio of the gas separation membrane 1 may decrease. Meanwhile, when the thickness of the porous layer 3 exceeds the above upper limit value, a pressure loss when a gas passes through the pores 31 in the porous layer 3 increases, and gas permeability of the porous layer 3 may decrease.

The thickness of the porous layer 3 is obtained as follows. First, a cross section of the porous layer 3 is processed by focused ion beam processing or the like. Next, the obtained cross section is observed with a scanning electron microscope (SEM) or a scanning transmission electron microscope (STEM). Next, a range of the porous layer 3 is extracted based on a contrast of an observation image. Next, a thickness of the extracted porous layer 3 is measured at five locations. An average value of the measured thicknesses is defined as the thickness of the porous layer 3.

An average pore diameter of the porous layer 3 is preferably 10 nm or more and 10,000 nm or less, more preferably 20 nm or more and 1,000 nm or less, and further preferably 30 nm or more and 500 nm or less. When the average pore diameter is within the above range, the porous layer 3 having good gas permeability and necessary and sufficient mechanical strength can be obtained. When the separation layer 2 moderately penetrates into the pores 31 of the porous layer 3, adhesion and coverage of the separation layer 2 are enhanced. As a result, a gas selectivity ratio of the separation layer 2 is increased.

When the average pore diameter of the porous layer 3 falls below the above lower limit value, a pressure loss when a gas passes through the pores 31 in the porous layer 3 increases, and the gas permeability of the porous layer 3 may decrease. Since the permeation of the separation layer 2 can be suppressed, the gas selectivity ratio of the separation layer 2 may decrease. Meanwhile, when the average pore diameter of the porous layer 3 exceeds the above upper limit value, the mechanical strength of the porous layer 3 may decrease, and breakage or the like may occur. In this case, the separation layer 2 cannot be sufficiently held by the porous layer 3, and the gas selectivity ratio of the gas separation membrane 1 may decrease. Since retention of the separation layer 2 decreases, coverage of the separation layer 2 may decrease and the separation layer 2 may become more susceptible to breakage.

The average pore diameter of the porous layer 3 is obtained as follows. FIG. 2 is a schematic view illustrating a method for measuring an average pore diameter in an observation image of a cross section of the porous layer 3.

First, a cross section of the porous layer 3 is processed by focused ion beam processing or the like. Next, the obtained cross section is observed with a scanning electron microscope (SEM) or a scanning transmission electron microscope (STEM). FIG. 2 is an example of the observation image obtained in this manner. Next, based on a contrast of the observation image, a range of the porous layer 3 and the pores 31 penetrating through that range in a thickness direction are extracted. Next, inner diameters of the extracted pores 31 at three locations in the thickness direction (an inner diameter d3-1 closest to the separation layer 2, an inner diameter d3-2 at a central portion, and an inner diameter d3-3 closest to an opposite side of the separation layer 2) are measured. Next, inner diameters of five pores 31 are similarly measured. An average value of the obtained 15 pieces of data is defined as the average pore diameter of the porous layer 3.

An aperture rate of the porous layer 3 is preferably 40% or more and 80% or less, and more preferably 50% or more and 70% or less. When the aperture rate is within the above range, the porous layer 3 having good gas permeability and necessary and sufficient mechanical strength can be obtained.

When the aperture rate of the porous layer 3 falls below the above lower limit value, a pressure loss when a gas passes through the pores 31 in the porous layer 3 increases, and the gas permeability of the porous layer 3 may decrease. Meanwhile, when the aperture rate of the porous layer 3 exceeds the above upper limit value, the mechanical strength of the porous layer 3 may decrease, and breakage or the like may occur. In this case, the separation layer 2 cannot be stably supported by the porous layer 3, and the gas selectivity ratio of the gas separation membrane 1 may decrease.

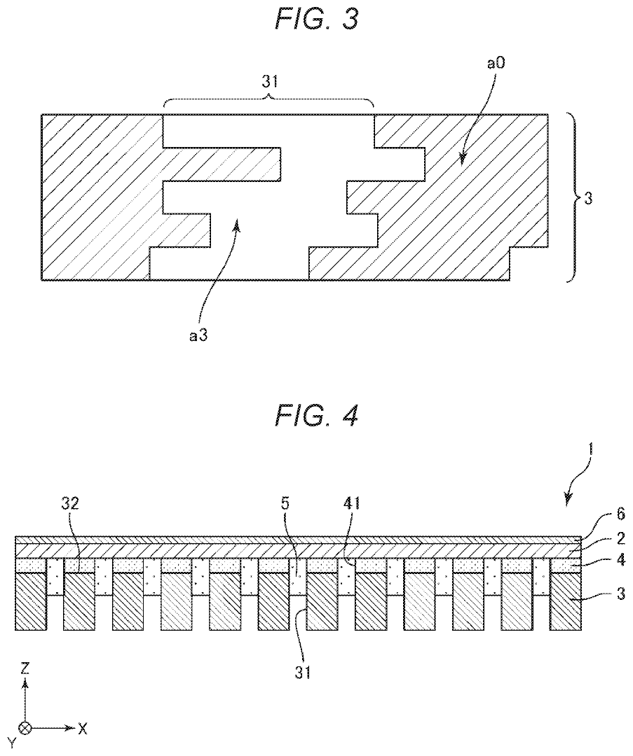

The aperture rate of the porous layer 3 is obtained as follows. FIG. 3 is a schematic view illustrating a method for measuring an aperture rate in the observation image of the cross section of the porous layer 3.

First, a cross section of the porous layer 3 is processed by focused ion beam processing or the like. Next, the obtained cross section is observed with a scanning electron microscope (SEM) or a scanning transmission electron microscope (STEM). FIG. 3 is an example of the observation image obtained in this manner. Next, after binarization processing is performed on the observation image, a range of the porous layer 3 and the pores 31 penetrating through that range in the thickness direction are extracted based on a contrast. Next, in the observation image, an area a3 of the pore 31 and an area a0 of the porous layer 3 other than the pore 31 are measured. An area rate is calculated by a calculation formula a3/a0×100, and a calculation result is defined as the aperture rate of the porous layer 3.

A maximum height roughness of the upper surface 32 (surface facing the separation layer 2) of the porous layer 3 is preferably 1 nm or more and 200 nm or less, more preferably 3 nm or more and 150 nm or less, and further preferably 5 nm or more and 120 nm or less. When the maximum height roughness of the upper surface 32 is within the above range, the coverage of the separation layer 2 can be sufficiently increased. An increase in difficulty in forming the porous layer 3 can be suppressed. When the maximum height roughness of the upper surface 32 of the porous layer 3 falls below the above lower limit value, the difficulty in forming the porous layer 3 may increase. Meanwhile, when the maximum height roughness of the upper surface 32 of the porous layer 3 exceeds the above upper limit value, continuity of the separation layer 2 formed at the upper surface 32 is impaired, and the coverage of the separation layer 2 may decrease.

The maximum height roughness of the upper surface 32 of the porous layer 3 is obtained as follows.

First, the porous layer 3 is set in a surface roughness measuring apparatus such that the upper surface 32 of the porous layer 3 serves as an observation target surface. For example, a laser microscope equipped with a white light interferometer is used as the measuring apparatus. Examples of such a laser microscope include VK-X3000 manufactured by Keyence Corporation. Then, a shape of the upper surface 32 is scanned at a magnification of 50 times. Accordingly, an image including information on an uneven shape of the upper surface 32 is acquired. Next, in the image, a highest point and a lowest point are specified in a range excluding the pores 31 of the porous layer 3. Next, a height difference between the two points is calculated and the height difference is set as the maximum height roughness. That is, a maximum height difference is obtained in a portion excluding the pores 31 based on a measurement result of the uneven shape of the upper surface 32, and the maximum height difference is set as the maximum height roughness.

### 1.2. Separation Layer

The separation layer 2 is provided at the upper surface 32 of the porous layer 3. The separation layer 2 has a function of separating a predetermined component such as carbon dioxide by allowing the predetermined component to permeate therethrough.

A constituent material of the separation layer 2 is the organopolysiloxane. One molecule of the organopolysiloxane includes at least a unit represented by R¹SiO_{3/2} (T unit), a unit represented by R²R³SiO_{2/2} (D unit), and a unit represented by R⁴R⁵R⁶SiO_{1/2} (M unit) as a basic constituent unit. In each unit, R¹ to R⁶ are an aliphatic hydrocarbon or a hydrogen atom. The organopolysiloxane is formed by combining the T unit, the D unit, and the M unit.

Specific examples of the organopolysiloxane include polydimethylsiloxane, polymethylphenylsiloxane, polydiphenylsiloxane, polysulfone/polyhydroxystyrene/polydimethylsiloxane copolymer, a dimethylsiloxane/methylvinylsiloxane copolymer, dimethylsiloxane/diphenylsiloxane/methylvinylsiloxane copolymer, methyl-3,3,3-trifluoropropylsiloxane/methylvinylsiloxane copolymer, dimethylsiloxane/methylphenylsiloxane/methylvinylsiloxane copolymer, vinyl terminated diphenylsiloxane/dimethylsiloxane copolymer, vinyl terminated polydimethylsiloxane, amino terminated polydimethylsiloxane, phenyl terminated polydimethylsiloxane, H terminated polydimethylsiloxane, and dimethylsiloxane-methylhydrosiloxane copolymer. The expression “vinyl terminated” or the like indicates that at least one end of a principal chain contained in the organopolysiloxane is substituted with a substituent such as a vinyl group. This includes a form in which a crosslinking reactant is formed. The constituent material of the separation layer 2 may be one kind or a composite of two or more kinds thereof, or may be a composite material containing an organopolysiloxane as a main component in mass ratio and other resin components in combination.

The organopolysiloxane has good affinity particularly to carbon dioxide. Therefore, the separation layer 2 containing an organopolysiloxane exhibits a high gas selectivity ratio to carbon dioxide.

If necessary, any functional group may be introduced into an upstream surface of the separation layer 2 using a coupling agent or the like. By appropriately selecting the functional group, affinity for a predetermined component such as carbon dioxide can be further enhanced.

A thickness of the separation layer 2 is not particularly limited, and is preferably 1 nm or more and 1000 nm or less, more preferably 2 nm or more and 500 nm or less, further preferably 3 nm or more and 100 nm or less, and particularly preferably 5 nm or more and 50 nm or less. Accordingly, the separation layer 2 has good gas selectivity ratio and gas permeability. As a result, the gas separation membrane 1 that can reduce an input amount of energy required for separating carbon dioxide, specifically, that can reduce a pressure difference between upstream and downstream of the gas separation membrane 1 can be achieved. When the thickness of the separation layer 2 falls below the above lower limit value, the coverage of the separation layer 2 may decrease or the separation layer 2 may be easily damaged, and the gas selectivity ratio of the separation layer 2 may decrease. Meanwhile, when the thickness of the separation layer 2 exceeds the above upper limit value, the gas permeability of the separation layer 2 may decrease, the input amount of energy required for separation may increase, and flexibility of the separation layer 2 may decrease.

The thickness of the separation layer 2 can be obtained, for example, by observing a cross section of the gas separation membrane 1 under magnification and calculating an average value of thicknesses measured at 10 locations. For the magnification observation, for example, a scanning electron microscope (SEM), or a scanning transmission electron microscope (STEM) is used. The thickness of the separation layer 2 may be measured by depth direction analysis using X-ray photoelectron spectroscopy, and the measured value may be set as the thickness of the separation layer 2.

### 1.3. Adhesive Layer

The adhesive layer 4 is provided between the porous layer 3 and the separation layer 2 and is made of a thermoplastic resin.

Examples of the thermoplastic resin include polyvinyl acetate, polyvinyl alcohol, polyvinyl butyral, polystyrene, acrylonitrile butadiene styrene (ABS) resin, methacrylic resin, Noryl resin, ionomer resin, cellulose-based plastic, polyolefin, polyamide, polycarbonate, polyacetal, polyphenylene sulfide, polyvinylidene chloride, polyester, and waxes, and one or two or more thereof may be used in combination.

Among these, the polyolefins or waxes are preferably used as the thermoplastic resin, and the waxes are more preferably used. Since the polyolefin is chemically stable, the polyolefin contributes to achieving the adhesive layer 4 having excellent durability. Since the waxes have a low molecular weight, thermal melting is easy, and film formation by a vapor phase film formation method such as vapor deposition is possible. Accordingly, it is possible to achieve the adhesive layer 4 which has sufficient adhesive force even when the adhesive layer 4 is thin and is less likely to cause a decrease in gas separation ability.

Examples of polyolefin include polyethylene and polypropylene.

Examples of waxes include natural waxes such as vegetable waxes such as candelilla wax, carnauba wax, rice wax, Japan wax, and jojoba oil, animal waxes such as beeswax, lanolin, and spermaceti, mineral waxes such as montan wax, ozokerite, and ceresin, and petroleum-based waxes such as paraffin wax, microcrystalline wax, and petrolatum, and synthetic waxes such as synthetic hydrocarbons such as polyethylene wax, modified waxes such as montan wax derivatives, paraffin wax derivatives, and microcrystalline wax derivatives, hydrogenated waxes such as hydrogenated castor oil and hydrogenated castor oil derivatives, fatty acids such as 12-hydroxystearic acid, acid amides such as stearic acid amide, and esters such as phthalic anhydride imide.

Among these, the petroleum-based waxes, the synthetic hydrocarbons, or the modified waxes are preferably used as the waxes, the petroleum-based waxes are more preferably used, and the paraffin wax or the microcrystalline wax is further preferably used. They have a low molecular weight and have a relatively low melting point and melt viscosity. Therefore, by using these waxes, it is possible to achieve the adhesive layer 4 that can be thermally melted and formed into a film at a relatively low temperature.

A molecular weight of the thermoplastic resin is preferably 200 or more and 1000 or less, and more preferably 300 or more and 550 or less. By setting the molecular weight of the thermoplastic resin within the above range, the adhesive layer 4 having particularly good adhesive properties can be obtained. Since a temperature range of the thermal melting and a temperature range during the film formation can be optimized, when the separation layer 2 and the porous layer 3 are adhered to each other via the adhesive layer 4, a thermal influence on the separation layer 2 is reduced to be small. Accordingly, the gas separation membrane 1 having a good gas separation ability and good durability can be obtained.

When the molecular weight of the thermoplastic resin falls below the above lower limit value, adhesive force of the adhesive layer 4 may decrease or heat resistance of the adhesive layer 4 may decrease. Meanwhile, when the molecular weight of the thermoplastic resin exceeds the above upper limit value, it may be difficult to form the adhesive layer 4 by a vapor phase film formation method such as vapor deposition. In addition, a thermal influence increases at the time of adhering, and the gas separation ability of the separation layer 2 may decrease.

A melting point of the thermoplastic resin is not particularly limited, and is preferably 40 °C or higher and 120 °C or lower, and more preferably 50 °C or higher and 80 °C or lower. When the melting point of the thermoplastic resin is within the above range, film formability of the adhesive layer 4 and adhesion workability due to thermal melting of the adhesive layer 4 can be enhanced while ensuring the heat resistance of the adhesive layer 4. As a result, the gas separation membrane 1 having a good gas separation ability and good durability can be obtained.

A thickness of the adhesive layer 4 is preferably 5 nm or more and 200 nm or less, and more preferably 10 nm or more and 150 nm or less. Accordingly, the adhesive layer 4 has sufficient adhesive force. As a result, the separation layer 2 can be well supported, and the separation layer 2 can be made sufficiently thin accordingly. Therefore, gas permeability of carbon dioxide in the gas separation membrane 1 can be sufficiently increased. That is, by setting the thickness of the adhesive layer 4 in this manner, it is possible to achieve the gas separation membrane 1 capable of reducing damage such as peeling even when the separation layer 2 is thin.

The thickness of the adhesive layer 4 can be obtained, for example, by observing the cross section of the gas separation membrane 1 under magnification and calculating an average value of thicknesses measured at 10 locations. In the present specification, the term “thickness” refers to a thickness in a laminating direction (Z-axis direction) in which the porous layer 3 and the separation layer 2 are laminated. For the magnification observation, for example, a scanning electron microscope (SEM), or a scanning transmission electron microscope (STEM) is used.

The adhesive layer 4 may be a coating film formed using a raw material liquid, but is preferably a vapor deposition film formed by a vapor deposition method. The vapor deposition film is easily thinned, and when formed at a surface of the porous layer 3, a probability of filling the pores 31 is low. Therefore, by using the vapor deposition film, the separation layer 2 can be well adhered to the porous layer 3 without impairing the good gas permeability of the porous layer 3.

The adhesive layer 4 preferably has a porous structure. In the present specification, the porous structure refers to a structure having through holes 41 penetrating the adhesive layer 4 in the thickness direction. Specifically, as illustrated in FIG. 1, the structure has the through hole 41 that reflects a position and a shape of an opening of the pore 31 in the porous layer 3. By having such a porous structure, it is possible to achieve the adhesive layer 4 in which the porous layer 3 and the separation layer 2 are well adhered to each other and the good gas permeability of the porous layer 3 is less likely to be reduced.

### 1.4. Impregnation Layer

The impregnation layer 5 penetrates into the pores 31 of the porous layer 3. The impregnation layer 5 preferably has a gas separation ability that allows carbon dioxide to permeate through. Accordingly, the gas separation ability can be imparted not only to the separation layer 2 but also to the impregnation layer 5, so that the gas separation membrane 1 can be improved in performance. By adopting a structure in which the impregnation layer 5 is impregnated into the pores 31 of the porous layer 3, the impregnation layer 5 itself is not required to have mechanical strength. Therefore, a material giving priority to the gas separation ability can be used as a constituent material of the impregnation layer 5. As a result, the gas separation membrane 1 having both good gas permeability and a good gas selectivity ratio can be achieved.

A thickness of the impregnation layer 5 may be equal to or less than the thickness of the separation layer 2, but is preferably set to be larger than that of the separation layer 2. Accordingly, a gas selectivity ratio of the impregnation layer 5 can be sufficiently increased.

When the thickness of the separation layer 2 is 1, the thickness of the impregnation layer 5 is preferably 5 or more and 1000 or less, and more preferably 10 or more and 500 or less. Accordingly, it is possible to sufficiently ensure the thickness of the impregnation layer 5 while reducing the thickness of the separation layer 2. As a result, in the gas separation membrane 1, a balance between the gas permeability and the gas selectivity ratio is improved.

The thickness of the impregnation layer 5 is not particularly limited, and is preferably 100 nm or more and 10,000 nm or less, and more preferably 200 nm or more and 5,000 nm or less. When the thickness of the impregnation layer 5 is within the above range, the impregnation layer 5 having a good gas selectivity ratio is obtained while the impregnation layer 5 is retained in the pores 31 of the porous layer 3.

The thickness of the impregnation layer 5 can be obtained, for example, by observing the cross section of the gas separation membrane 1 under magnification and calculating an average value of thicknesses measured at 10 locations.

A form of the impregnation layer 5 may be a solid, but is preferably a liquid. In a case of the liquid, since a penetration force using a capillary phenomenon acts, a filling property in the pores 31 is easily enhanced. Therefore, when the impregnation layer 5 is a liquid, a rate of the pores 31 that are not permeated with the impregnation layer 5 decreases, and thus the gas selectivity ratio is particularly increased.

When the form of the impregnation layer 5 is a liquid, the impregnation layer 5 preferably contains an ionic liquid. The ionic liquid has an advantage of being nonvolatile and having high heat resistance. Therefore, when the impregnation layer 5 contains an ionic liquid, volatilization of the impregnation layer 5 due to permeation of gas or temperature rise can be reduced.

The ionic liquid is not particularly limited as long as the ionic liquid has a gas separation ability of carbon dioxide. Examples thereof include 1-ethyl-3-methylimidazolium acetate.

The impregnation layer 5 may protrude from an inside of the pores 31 to a lower surface side of the porous layer 3.

Since the adhesive layer 4 well adheres the separation layer 2 and the porous layer 3, leakage of the impregnation layer 5 can be reduced even when the form of the impregnation layer 5 is a liquid.

### 1.5. Another Configuration

Although the gas separation membrane 1 according to the embodiment has been described above, any layer may be provided at at least one of an upstream side of the separation layer 2 and a downstream side of the porous layer 3. For example, a porous plate having higher rigidity and higher gas permeability than the porous layer 3 may be provided at the downstream side of the porous layer 3.

### 2. Modifications

Next, a gas separation membrane according to the modification of the embodiment will be described.

FIG. 4 is a cross-sectional view illustrating the gas separation membrane 1 according to the modification of the embodiment.

The modification will hereinafter be described, but in the following description, differences from the embodiment described above will mainly be described, and description of similar matters will be omitted. In FIG. 4, similar configurations to those in the embodiment described above are provided with the same reference symbols.

The modification is similar to the above-described embodiment except that a surface layer 6 is added.

The surface layer 6 illustrated in FIG. 4 is provided at the upstream side of the separation layer 2 (an opposite side of the separation layer 2 from the porous layer 3). The surface layer 6 has a function with high affinity for carbon dioxide, for example. By adding the surface layer 6 having such a function, the gas separation ability of the gas separation membrane 1 can be further enhanced.

The surface layer 6 contains a polyether or a polylactic acid. By including these polymers, the surface layer 6 having particularly high affinity for carbon dioxide can be achieved.

Examples of the polyether include polyethersulfone, polyetherimide, polyetheretherketone, and polyetheramine.

Examples of the polylactic acid include L-type polylactic acid (PLLA) and D-type polylactic acid (PDLA).

A thickness of the surface layer 6 may be larger than that of the separation layer 2, but is preferably set to be smaller than that of the separation layer 2. Accordingly, the surface layer 6 can minimize a decrease in gas permeability caused by providing the surface layer 6 while promoting permeation of carbon dioxide by utilizing affinity for carbon dioxide.

When the thickness of the separation layer 2 is 1, the thickness of the surface layer 6 is preferably 0.01 or more and less than 1, and more preferably 0.1 or more and 0.7 or less.

The thickness of the surface layer 6 is not particularly limited, and is preferably 5 nm or more and 200 nm or less, and more preferably 10 nm or more and 150 nm or less.

The thickness of the surface layer 6 can be obtained, for example, by observing the cross section of the gas separation membrane 1 under magnification and calculating an average value of thicknesses measured at 10 locations.

In such a modification as described above, similar effects to those of the embodiment described above can be obtained.

### 3. Method for Producing Gas Separation Membrane

Next, the method for producing the gas separation membrane according to the embodiment will be described. In the following description, the method for producing the gas separation membrane 1 illustrated in FIGS. 1 and 4 will be described as an example.

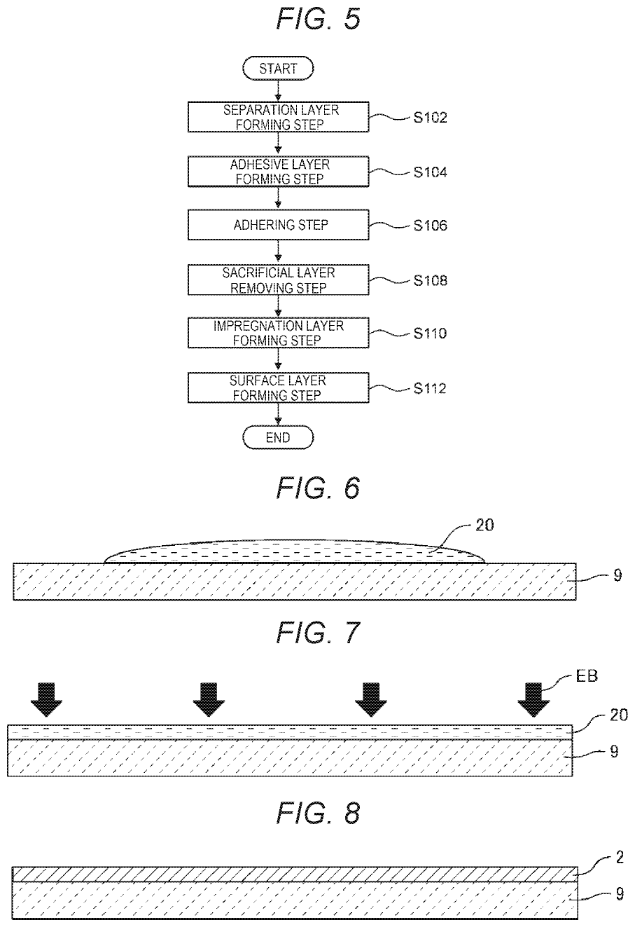

FIG. 5 is a process chart illustrating the method for producing the gas separation membrane 1 illustrated in FIGS. 1 and 4 (the method for producing the gas separation membrane according to the embodiment). FIGS. 6 to 15 are cross-sectional views illustrating the method for producing the gas separation membrane illustrated in FIG. 5.

The method for producing the gas separation membrane 1 illustrated in FIG. 5 includes a separation layer forming step S102, an adhesive layer forming step S104, an adhering step S106, a sacrificial layer removing step S108, an impregnation layer forming step S110, and a surface layer forming step S112.

In the separation layer forming step S102, the separation layer 2 made of an organopolysiloxane is formed at one surface of a sacrificial layer 9. In the adhesive layer forming step S104, the adhesive layer 4 is formed at one surface of the porous layer 3. In the adhering step S106, the porous layer 3 and the separation layer 2 are adhered via the adhesive layer 4 made of a thermoplastic resin. In this adhesion, thermal fusion of the adhesive layer 4 is used. In the sacrificial layer removing step S108, the sacrificial layer 9 is removed.

According to such a configuration, since the adhesive layer 4 is made of a thermoplastic resin, the adhesive properties of the thermoplastic resin enable the porous layer 3 and the separation layer 2 to be firmly adhered. Therefore, even when the separation layer 2 is made of the organopolysiloxane and surface energy of the separation layer 2 is low, it is possible to produce the gas separation membrane 1 capable of reducing damage such as peeling between layers. Since the adhesive layer 4 is formed at the one surface of the porous layer 3, the porous structure of the porous layer 3 is reflected in the adhesive layer 4. Accordingly, it is possible to efficiently form the adhesive layer 4 that has adhesion and is less likely to inhibit gas permeability of the porous layer 3. Hereinafter, each step will be described.

### 3.1. Separation Layer Forming Step

In the separation layer forming step S102, first, the sacrificial layer 9 illustrated in FIG. 6 is prepared. The sacrificial layer 9 is not particularly limited as long as the sacrificial layer 9 is a base material having releasability, and is, for example, a resin film. Examples of the resin film include a polyolefin film such as a polyethylene film and a polypropylene film, and a polyester film such as a polyethylene terephthalate film. The sacrificial layer 9 preferably has flexibility in consideration of being removed in the sacrificial layer removing step S108.

Next, as illustrated in FIG. 6, a raw material liquid 20 is placed at one surface of the sacrificial layer 9 and applied to have a uniform thickness. A coating method is not particularly limited, and examples thereof include a spin coating method, a bar coating method, a spray coating method, and an immersion method. The raw material liquid 20 is a liquid containing a raw material of the separation layer 2. Examples of the raw material include a prepolymer of the organopolysiloxane.

Next, the applied raw material liquid 20 (coating film) is subjected to a curing treatment. Examples of the curing treatment include irradiation with an electron beam EB as illustrated in FIG. 7, irradiation with ultraviolet rays, and irradiation with plasma. Among these, considering that efficiency of a reaction for converting into the separation layer 2 is easily increased, an influence on the sacrificial layer 9 is small, and the like, the electron beam EB or the plasma treatment is preferably used. By the curing treatment, a crosslinking reaction occurs in the prepolymer, and the separation layer 2 illustrated in FIG. 8 is obtained.

The method for forming the separation layer 2 is not limited thereto.

### 3.2. Adhesive Layer Forming Step

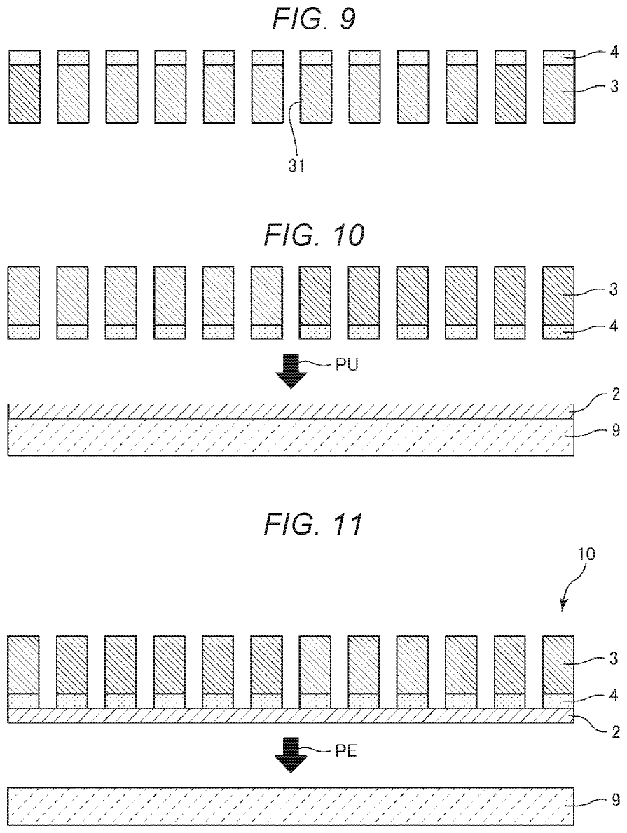

In the adhesive layer forming step S104, first, the porous layer 3 illustrated in FIG. 9 is prepared.

Next, as illustrated in FIG. 9, the adhesive layer 4 made of a thermoplastic resin is formed at the one surface of the porous layer 3. Examples of a method for forming the adhesive layer 4 include a vapor phase film formation method such as a vapor deposition method and a sputtering method, and a liquid phase film formation method such as a coating method and a printing method. Among them, the vapor phase film formation method is preferably used, and the vapor deposition method is more preferably used. In these methods, when the adhesive layer 4 is formed at the porous layer 3, the adhesive layer 4 can be formed so as not to fill the pores 31 of the porous layer 3. Therefore, the adhesive layer 4 having a porous structure can be efficiently formed.

### 3.3. Adhering Step

In the adhering step S106, the porous layer 3 and the separation layer 2 are adhered via the adhesive layer 4. Specifically, as indicated by an arrow PU in FIG. 10, the adhesive layer 4 formed at the porous layer 3 and the separation layer 2 formed at the sacrificial layer 9 are stacked together so as to adhere to each other to obtain a laminate. Subsequently, the obtained laminate is heated.

A heating temperature may be higher than a melting point of the adhesive layer 4, and is preferably set to a temperature 10 °C or higher than the melting point of the adhesive layer 4. Accordingly, the porous layer 3 and the separation layer 2 can be thermally fused via the adhesive layer 4. An upper limit value of the heating temperature is not particularly set, and is preferably 50 °C or higher than the melting point.

A heating time is not particularly limited, and is preferably 1 second or more and 60 seconds or less, and more preferably 3 seconds or more and 20 seconds or less.

Thereafter, a temperature of the adhesive layer 4 is lowered. Accordingly, the adhesive layer 4 is solidified to exhibit adhesive force.

If necessary, the porous layer 3, the adhesive layer 4, and the separation layer 2 under heating may be pressurized in the thickness direction. Accordingly, the adhesive force can be improved.

### 3.4. Sacrificial Layer Removing Step

In the sacrificial layer removing step S108, as indicated by an arrow PE in FIG. 11, the sacrificial layer 9 is peeled off and removed from the separation layer 2 after adhesion. Accordingly, an adhesive body 10 illustrated in FIG. 11 is obtained.

Examples of a method of removing the sacrificial layer 9 include a method of peeling off the sacrificial layer 9 using flexibility of the sacrificial layer 9, and a method of dissolving or decomposing and removing the sacrificial layer 9.

### 3.5. Impregnation Layer Forming Step

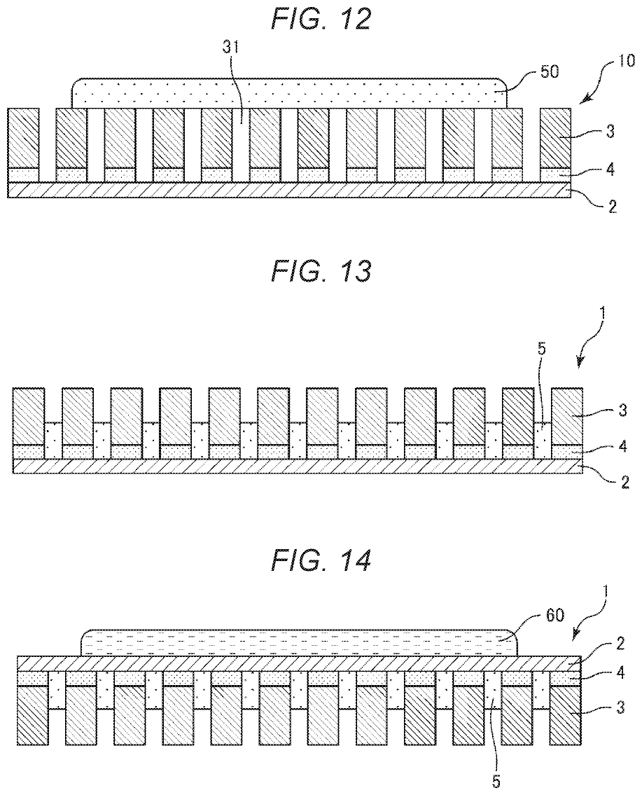

In the impregnation layer forming step S110, as illustrated in FIG. 12, a raw material liquid 50 is brought into contact with the adhesive body 10. The raw material liquid 50 is a liquid containing a raw material of the impregnation layer 5. When the impregnation layer 5 is made of an ionic liquid, the ionic liquid can be used as it is in the raw material liquid 50. The raw material of the impregnation layer 5 may be a precursor of a constituent material of the impregnation layer 5.

Next, pressure around the adhesive body 10 that has been brought into contact with the raw material liquid 50 is reduced. An ultimate vacuum degree during the reduction of pressure is not particularly limited, and is preferably 10 kPa or less, and more preferably 5 kPa or less. As an example, a retention time of the ultimate vacuum degree is preferably 5 seconds or longer, and more preferably 10 seconds or longer and 300 seconds or shorter. Accordingly, pressure inside the pores 31 of the porous layer 3 can be sufficiently reduced. As a result, the raw material liquid 50 can efficiently permeate into the pores 31.

After the raw material liquid 50 is allowed to permeate into the porous layer 3, a reaction treatment or the like may be performed on the raw material liquid 50 as necessary.

As described above, the gas separation membrane 1 having the impregnation layer 5 illustrated in FIG. 13 is obtained.

### 3.6. Surface Layer Forming Step

In the surface layer forming step S112, as illustrated in FIG. 14, a raw material liquid 60 is brought into contact with the separation layer 2 of the gas separation membrane 1 having the impregnation layer 5. The raw material liquid 60 is a liquid containing a raw material of the surface layer 6. When the surface layer 6 contains a polyether or a polylactic acid, a solution thereof or a solution of a precursor thereof is used as the raw material liquid 60. Next, the raw material liquid 60 is spread by various coating methods to obtain a coating film of the raw material liquid 60.

Next, the coating film is dried. Accordingly, the surface layer 6 is obtained. If necessary, for example, a precursor reaction treatment may be performed.

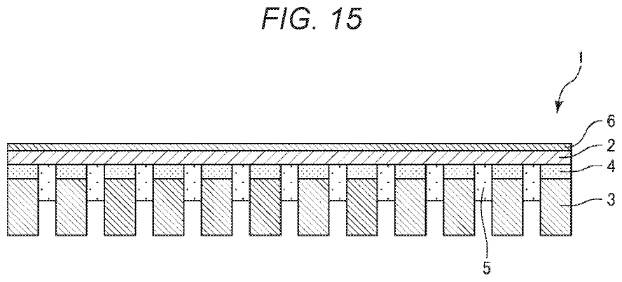

As described above, the gas separation membrane 1 having the surface layer 6 illustrated in FIG. 15 is obtained.

### 4. Use of Gas Separation Membrane

The gas separation membrane 1 according to the embodiment can be used for, for example, carbon dioxide separation and collection from a mixed gas containing carbon dioxide, and carbon dioxide separation and purification. In particular, it is effective to use the gas separation membrane 1 in a technique for separating and collecting carbon dioxide contained in the atmosphere (direct air recovery (DAC)).

### 5. Effects Exerted by Embodiments

The gas separation membrane 1 according to the embodiment is a gas separation membrane that separates a predetermined component from a mixed gas by allowing the predetermined component to permeate therethrough, and includes the porous layer 3, the separation layer 2, and the adhesive layer 4. The porous layer 3 is porous. The separation layer 2 is made of an organopolysiloxane. The adhesive layer 4 is provided between the porous layer 3 and the separation layer 2, and adheres the porous layer 3 and the separation layer 2. The adhesive layer 4 is made of a thermoplastic resin.

According to such a configuration, it is possible to obtain the gas separation membrane 1 which has good gas separation ability, can enhance the adhesion between the separation layer 2 made of the organopolysiloxane and the porous layer 3, and can reduce damage such as peeling between layers.

In the gas separation membrane 1 according to the embodiment, the thickness of the adhesive layer 4 in the laminating direction in which the porous layer 3 and the separation layer 2 are laminated is preferably 5 nm or more and 200 nm or less.

According to such a configuration, the adhesive layer 4 has sufficient adhesive force. As a result, the separation layer 2 can be well supported, and the separation layer 2 can be made sufficiently thin accordingly. Therefore, gas permeability of carbon dioxide in the gas separation membrane 1 can be sufficiently increased.

In the gas separation membrane 1 according to the embodiment, the molecular weight of the thermoplastic resin is preferably 200 or more and 1,000 or less.

According to such a configuration, the adhesive layer 4 having particularly good adhesive properties is obtained. Since a temperature range of the thermal melting and a temperature range during the film formation can be optimized, when the separation layer 2 and the porous layer 3 are adhered to each other via the adhesive layer 4, a thermal influence on the separation layer 2 is reduced to be small. Accordingly, the gas separation membrane 1 having a good gas separation ability and good durability can be obtained.

The gas separation membrane 1 according to the embodiment may further include the impregnation layer 5. The impregnation layer 5 is impregnated into the porous layer 3 and has a gas separation ability.

According to such a configuration, the gas separation ability can be imparted not only to the separation layer 2 but also to the impregnation layer 5, so that the gas separation membrane 1 can be improved in performance. By adopting the structure in which the impregnation layer 5 is impregnated into the pores 31 of the porous layer 3, the impregnation layer 5 itself is not required to have mechanical strength. Therefore, a material giving priority to the gas separation ability can be used as the constituent material of the impregnation layer 5.

In the gas separation membrane 1 according to the embodiment, the impregnation layer 5 preferably contains an ionic liquid.

According to such a configuration, since the ionic liquid is nonvolatile and has high heat resistance, it is possible to achieve the impregnation layer 5 in which volatilization due to permeation of gas or temperature rise is reduced.

In the gas separation membrane 1 according to the embodiment, the thickness of the impregnation layer 5 in the laminating direction in which the porous layer 3 and the separation layer 2 are laminated is preferably larger than the thickness of the separation layer 2.

According to such a configuration, the gas selectivity ratio of the impregnation layer 5 can be sufficiently increased.

The gas separation membrane 1 according to the embodiment may further include the surface layer 6. The surface layer 6 is provided at the opposite side of the separation layer 2 from the porous layer 3. The surface layer 6 contains the polyether or the polylactic acid.

According to such a configuration, since the surface layer 6 having particularly high affinity for carbon dioxide can be achieved, the gas separation ability of the gas separation membrane 1 can be further enhanced.

In the gas separation membrane 1 according to the embodiment, the thickness of the surface layer 6 is preferably smaller than the thickness of the separation layer 2.

According to such a configuration, in the surface layer 6, it is possible to minimize a decrease in gas permeability caused by providing the surface layer 6 while promoting permeation of carbon dioxide by utilizing affinity for carbon dioxide.

In the gas separation membrane 1 according to the embodiment, the thermoplastic resin is preferably a wax.

According to such a configuration, since the wax has a low molecular weight, is easily thermally melted, and can be formed by a vapor phase film formation method such as vapor deposition, it is possible to achieve the adhesive layer 4 which has sufficient adhesive force even when the adhesive layer 4 is thin and is less likely to cause a decrease in gas separation ability.

In the gas separation membrane 1 according to the embodiment, the adhesive layer 4 may be a vapor deposition film.

According to such a configuration, the adhesive layer 4 can be easily thinned, and when formed at the surface of the porous layer 3, a probability that the adhesive layer 4 fills the pores 31 can be reduced. Therefore, by using the vapor deposition film, the separation layer 2 can be well adhered to the porous layer 3 without impairing the good gas permeability of the porous layer 3.

In the gas separation membrane 1 according to the embodiment, the adhesive layer 4 preferably has a porous structure.

According to such a configuration, it is possible to achieve the adhesive layer 4 in which the porous layer 3 and the separation layer 2 are well adhered to each other and the good gas permeability of the porous layer 3 is less likely to be reduced.

The method for producing the gas separation membrane according to the embodiment includes the separation layer forming step S102, the adhesive layer forming step S104, the adhering step S106, and the sacrificial layer removing step S108. In the separation layer forming step S102, the separation layer 2 made of the organopolysiloxane is formed at the one surface of a sacrificial layer 9. In the adhesive layer forming step S104, the adhesive layer 4 is formed at the one surface of the porous layer 3. In the adhering step S106, the porous layer 3 and the separation layer 2 are adhered via the adhesive layer 4. In the sacrificial layer removing step S108, the sacrificial layer 9 is removed. The adhesive layer 4 is made of a thermoplastic resin. Further, in the adhering step, the porous layer 3 and the separation layer 2 adhere to each other by thermal fusion of the adhesive layer 4.

According to such a configuration, since the adhesive layer 4 is made of a thermoplastic resin, the adhesive properties of the thermoplastic resin enable the porous layer 3 and the separation layer 2 to be firmly adhered. Therefore, even when the separation layer 2 is made of the organopolysiloxane and surface energy of the separation layer 2 is low, it is possible to produce the gas separation membrane 1 capable of reducing damage such as peeling between layers. Since the adhesive layer 4 is formed at the one surface of the porous layer 3, the porous structure of the porous layer 3 is reflected in the adhesive layer 4. Accordingly, it is possible to efficiently form the adhesive layer 4 that has adhesion and is less likely to inhibit gas permeability of the porous layer 3.

In the method for producing the gas separation membrane according to the embodiment, the separation layer forming step S102 may include a treatment of forming the separation layer 2 by forming a coating film containing the organopolysiloxane and irradiating the coating film with the electron beam EB or plasma.

According to such a configuration, it is possible to easily increase efficiency of a reaction of forming the separation layer 2 while reducing an influence on the sacrificial layer 9.

In the method for producing the gas separation membrane according to the embodiment, the adhesive layer forming step S104 may include a treatment of forming the adhesive layer 4 by a vapor deposition method.

According to such a configuration, when the adhesive layer 4 is formed at the porous layer 3, the adhesive layer 4 can be formed so as not to fill the pores 31 of the porous layer 3. Therefore, the adhesive layer 4 having a porous structure can be efficiently formed.

Although the gas separation membrane and the method for producing a gas separation membrane according to the present disclosure have been described above based on the preferred embodiment, the present disclosure is not limited thereto.

For example, in the gas separation membrane according to the present disclosure, each part of the embodiment described above may be replaced with a component having a similar function, or any component may be added to the embodiment described above.

The method for producing a gas separation membrane according to the present disclosure may be one in which any purpose process is added to the above embodiment.

### EXAMPLES

Next, specific examples of the present disclosure will be described.

### 6. Preparation of Gas Separation Membrane

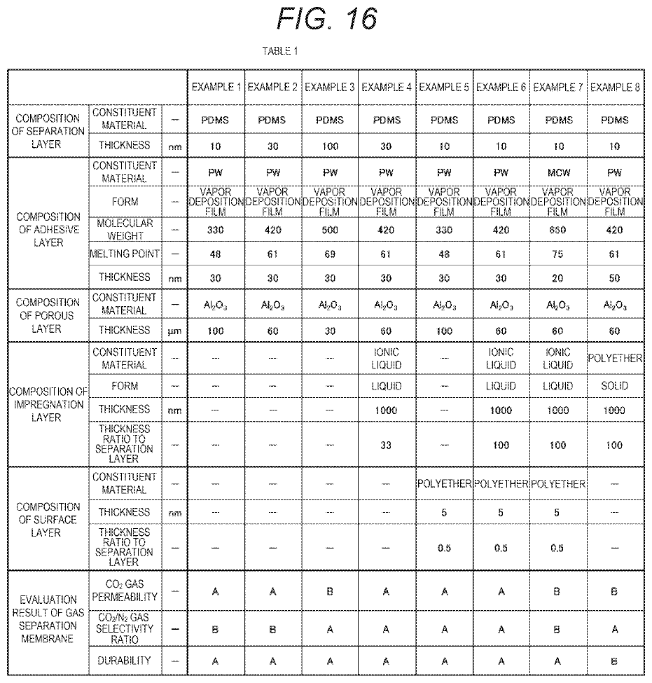

FIG. 16 is Table 1 illustrating compositions of gas separation membranes and evaluation results of the gas separation membranes in Examples.

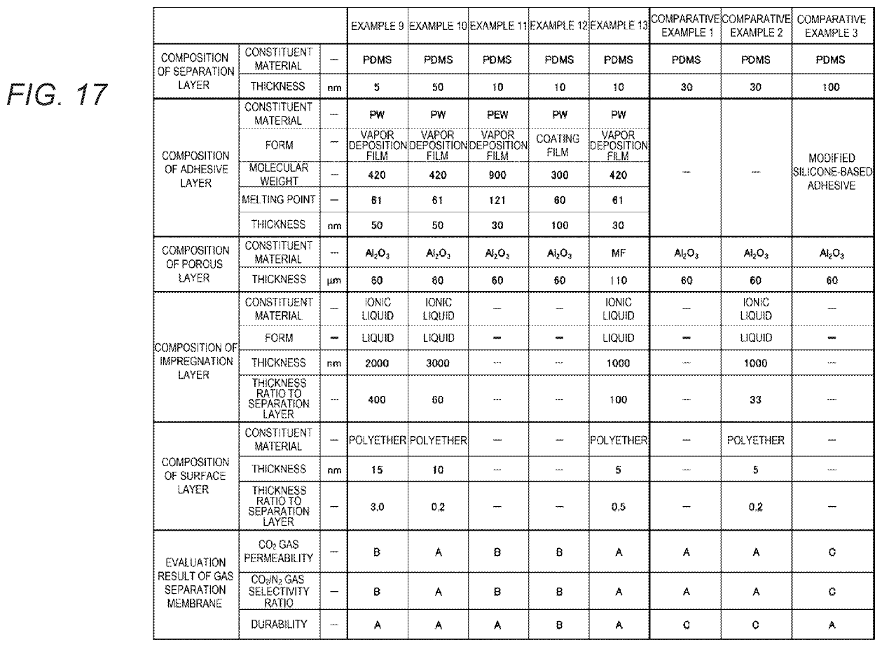

FIG. 17 is Table 2 illustrating compositions of gas separation membranes and evaluation results of the gas separation membranes in Examples and Comparative Examples.

### 6.1. Example 1

First, a Polyethylene Terephthalate Film (pet film) having a thickness of 25 μm was prepared. Subsequently, a raw material liquid was spin-coated on the PET film to obtain a coating film. As the raw material liquid, a liquid containing a prepolymer of polydimethylsiloxane (PDMS) was used.

Next, a surface of the coating film was irradiated with an electron beam. Accordingly, the prepolymer was crosslinked to form a separation layer having the composition illustrated in Table 1 (FIG. 16). Irradiation conditions of the electron beam are as follows.
Acceleration voltage of electron beam irradiation device: 50 kV
Irradiation time of electron beam: 2 seconds
Irradiation atmosphere of electron beam: nitrogen atmosphere

Next, a porous layer having a composition illustrated in Table 1 was prepared. Subsequently, an adhesive layer was formed on the porous layer by a vacuum deposition method. A paraffin wax (PW) having 40 carbon atoms was used as a vapor deposition raw material.

Next, the separation layer formed on the PET film and the adhesive layer formed on the porous layer were stacked together so as to be in contact with each other to form a laminate. Then, the laminate was heated at a temperature 10 °C higher than a melting point of the paraffin wax. Accordingly, the adhesive layer was thermally melted, and the separation layer and the porous layer were adhered to each other via the thermally melted adhesive layer.

Next, the laminate is cooled, and when the temperature decreases to below the melting point of the paraffin wax, the PET film is peeled off. At this time, the PET film was peeled off at a peel angle of 90° using flexibility of the PET film. Accordingly, the gas separation membrane in Example 1 was obtained.

### 6.2. Examples 2 and 3

The gas separation membrane was obtained in the same manner as in Example 1 except that the compositions of the separation layer, the adhesive layer, and the porous layer were changed as illustrated in Table 1.

### 6.3. Example 4

The gas separation membrane was obtained in the same manner as in Example 1 except that an impregnation layer having the composition illustrated in Table 1 was added and the compositions of the separation layer, the adhesive layer, and the porous layer were changed as illustrated in Table 1. A method for forming the impregnation layer is as follows.

First, an adhesive body was obtained by adhering the separation layer and the porous layer in the same manner as in Example 1.

Next, an ionic liquid and the adhesive body were brought into contact with each other. As the ionic liquid, 1-ethyl-3-methylimidazolium acetate was used.

Next, the adhesive body in contact with the ionic liquid was placed in a vacuum device, and pressure around the adhesive body was reduced. An ultimate vacuum degree during the reduction of pressure was 5000 Pa or less, and a retention time of the ultimate vacuum degree was 5 seconds or longer.

Next, the pressure around the container was returned to normal pressure. Accordingly, the impregnation layer obtained by impregnating the porous layer with the ionic liquid was formed to obtain the gas separation membrane in Example 4.

### 6.4. Example 5

The gas separation membrane was obtained in the same manner as in Example 1 except that a surface layer having the composition illustrated in Table 1 was added. A method for forming the surface layer is as follows.

First, an adhesive body was obtained by adhering the separation layer and the porous layer in the same manner as in Example 1.

Next, the separation layer of the adhesive body was spin-coated with a raw material liquid containing polyether to obtain a coating film. The coating film was dried to obtain the surface layer having the composition illustrated in Table 1.

### 6.5. Examples 6 and 7

The gas separation membrane was obtained in the same manner as in Example 1 except that the compositions of the separation layer, the adhesive layer, the porous layer, the impregnation layer, and the surface layer were changed as illustrated in Table 1.

The abbreviation in Table 1 corresponds to the following substance.
MCW: microcrystalline wax

### 6.6. Example 8

The gas separation membrane was obtained in the same manner as in Example 4 except that a method for forming the impregnation layer was changed to the following method.

First, a raw material liquid containing polyether was used instead of the ionic liquid, and the adhesive body was immersed in the raw material liquid.

Next, a container containing the raw material liquid was placed in a vacuum device, and pressure around the container was reduced. An ultimate vacuum degree during the reduction of pressure was 5000 Pa or less, and a retention time of the ultimate vacuum degree was 5 seconds or longer.

Next, the pressure around the container was returned to normal pressure. Accordingly, the porous layer was impregnated with the raw material liquid.

Next, the impregnated raw material liquid was dried. Accordingly, the impregnation layer was formed to obtain the gas separation membrane in Example 8.

### 6.7. Examples 9 and 10

The gas separation membrane was obtained in the same manner as in Example 1 except that the compositions of the separation layer, the adhesive layer, the porous layer, the impregnation layer, and the surface layer were changed as illustrated in Table 2 (FIG. 17).

### 6.8. Example 11

The gas separation membrane was obtained in the same manner as in Example 1 except that the compositions of the separation layer, the adhesive layer, and the porous layer were changed as illustrated in Table 2.

The abbreviation in Table 2 corresponds to the following substance.
PEW: polyethylene wax

### 6.9. Example 12

The gas separation membrane was obtained in the same manner as in Example 1 except that a form of the adhesive layer was changed from the vapor deposition film to the coating film and the compositions of the separation layer and the adhesive layer were changed as illustrated in Table 2. A method for forming the adhesive layer by a coating method is as follows.

First, a porous layer having the composition illustrated in Table 2 was prepared. Subsequently, the porous layer was spin-coated with a coating liquid. As the coating liquid, a paraffin solution prepared by dissolving paraffin wax (PW) having 40 carbon atoms in a solvent was used.

### 6.10. Example 13

The gas separation membrane was obtained in the same manner as in Example 1 except that a regenerated cellulose membrane filter was used as the porous layer, and the compositions of the separation layer, the adhesive layer, the porous layer, the impregnation layer, and the surface layer were changed as illustrated in Table 2.

### 6.11. Comparative Example 1

The gas separation membrane was obtained in the same manner as in Example 1 except that the adhesive layer was omitted and the compositions of the separation layer and the porous layer were changed as illustrated in Table 2. A method for producing the gas separation membrane is as follows.

First, a porous layer having the composition illustrated in Table 2 was prepared. Subsequently, a raw material liquid was spin-coated on the porous layer to obtain a coating film. As the raw material liquid, a liquid containing a prepolymer of polydimethylsiloxane (PDMS) was used.

Next, a surface of the coating film was irradiated with an electron beam. Accordingly, the prepolymer was crosslinked to form a separation layer having the composition illustrated in Table 2, thereby obtaining the gas separation membrane in Comparative Example 1.

### 6.12. Comparative Example 2

The gas separation membrane was obtained in the same manner as in Comparative Example 1 except that an impregnation layer and a surface layer having the compositions illustrated in Table 2 were added.

### 6.13. Comparative Example 3

The gas separation membrane was obtained in the same manner as in Comparative Example 1 except that a modified silicone-based adhesive was used as the adhesive layer and the composition of the separation layer was changed as illustrated in Table 2.

### 7. Evaluation of Gas Separation Membrane

The gas separation membranes in Examples and Comparative Examples were evaluated as follows.

### 7.1. Gas Permeability of CO₂

The gas separation membranes in Examples and Comparative Examples were set in a gas transmission rate measuring device.

Next, a mixed gas obtained by mixing carbon dioxide: nitrogen at a volume ratio of 5:95 was supplied to an upstream side of the gas separation membrane. At this time, a total upstream pressure was adjusted to 1.2 atm, a flow rate of the mixed gas was adjusted to 500 mL/min, and a temperature was adjusted to 40 °C.

Next, the gas permeability of carbon dioxide was measured by a gas transmission rate measuring device. The gas permeability was measured according to Determination of gas-transmission rate (Part 1: Differential-pressure method) specified in JIS K 7126-1: 2006. As the gas transmission rate measuring device, GTR-11A/31A manufactured by GTR TEC Corporation was used. In the device, a gas that permeated the test sample is introduced into a gas chromatograph, and the gas permeability of each component is measured.

Next, measurement results were relatively evaluated based on the following evaluation criteria. The evaluation results are shown in Tables 1 and 2.
A: Gas permeability of CO₂ is particularly high.
B: Gas permeability of CO₂ is lower than A, but there is no problem in practical use.
C: Gas permeability of CO₂ is low and is not suitable for practical use.
   7.2. CO₂/N₂ Gas Selectivity Ratio

Gas permeability of nitrogen in the gas separation membrane was calculated from the above-described analysis result. A ratio of the gas permeability of carbon dioxide to the gas permeability of nitrogen was calculated as the CO₂/N₂ gas selectivity ratio.

Next, calculation results were relatively evaluated based on the following evaluation criteria. The evaluation results are shown in Tables 1 and 2.
A: CO₂/N₂ gas selectivity ratio is particularly high.
B: CO₂/N₂ gas selectivity ratio is lower than A, but there is no problem in practical use.
C: CO₂/N₂ gas selectivity ratio is low.

### 7.3. Durability

In the measurement of the gas permeability described above, a test in which a total pressure on an upstream side was changed while replacing the gas separation membrane was performed. Subsequently, the gas separation membrane after the test was taken out from the gas transmission rate measuring device, and presence or absence of breakage was confirmed by magnifying observation. A scanning electron microscope was used for magnification observation. Then, observation results were evaluated in view of the following evaluation criteria. The evaluation results are shown in Tables 1 and 2.
A: No breakage is observed in the gas separation membrane even when the total pressure on the upstream side is set to 1.5 atm.
B: No breakage was observed when the total pressure on the upstream side was 1.2 atm, but breakage was observed when the total pressure was 1.5 atm.
C: Breakage was observed in the gas separation membrane when the total pressure on the upstream side was 1.2 atm.

As is clear from Tables 1 and 2, it was confirmed that the gas separation membranes in Examples had good gas separation ability and high durability. When the gas separation membrane in which breakage was observed in the durability test was observed, peeling was observed at an interface between the separation layer and the porous layer.

From the above results, it has been confirmed that in the gas separation membrane in Examples, adhesion between the separation layer and the porous layer is high, and damage such as peeling between layers can be reduced.

It was also confirmed that the gas separation ability (gas selectivity ratio) could be improved by adding at least one of the impregnation layer and the surface layer. In particular, when an ionic liquid was used as the impregnation layer, the tendency was significant.

Further, it was also confirmed that a vapor deposition film of wax is suitable for the adhesive layer.

What is claimed is:

1. A gas separation membrane for separating a predetermined component from a mixed gas by allowing the predetermined component to permeate therethrough, the gas separation membrane comprising:
a porous layer that is porous;
a separation layer made of an organopolysiloxane; and
an adhesive layer provided between the porous layer and the separation layer and adhering the porous layer and the separation layer, wherein
the adhesive layer is made of a thermoplastic resin.

2. The gas separation membrane according to claim 1, wherein
a thickness of the adhesive layer in a laminating direction in which the porous layer and the separation layer are laminated is 5 nm or more and 200 nm or less.

3. The gas separation membrane according to claim 1, wherein
a molecular weight of the thermoplastic resin is 200 or more and 1,000 or less.

4. The gas separation membrane according to claim 1, further comprising
an impregnation layer impregnated in the porous layer and having a gas separation ability.

5. The gas separation membrane according to claim 4, wherein
the impregnation layer contains an ionic liquid.

6. The gas separation membrane according to claim 4, wherein
a thickness of the impregnation layer in a laminating direction in which the porous layer and the separation layer are laminated is larger than a thickness of the separation layer.

7. The gas separation membrane according to claim 1, further comprising
a surface layer provided at an opposite side of the separation layer from the porous layer, wherein
the surface layer contains a polyether or a polylactic acid.

8. The gas separation membrane according to claim 7, wherein
a thickness of the surface layer is smaller than a thickness of the separation layer.

9. The gas separation membrane according to claim 1, wherein
the thermoplastic resin is a wax.

10. The gas separation membrane according to claim 1, wherein
the adhesive layer is a vapor deposition film.

11. The gas separation membrane according to claim 1, wherein
the adhesive layer has a porous structure.

12. A method for producing a gas separation membrane, comprising:
a separation layer forming step of forming a separation layer made of an organopolysiloxane at one surface of a sacrificial layer;
an adhesive layer forming step of forming an adhesive layer at one surface of the porous layer;
an adhering step of adhering the porous layer and the separation layer via the adhesive layer; and
a sacrificial layer removing step of removing the sacrificial layer, wherein
the adhesive layer is made of a thermoplastic resin, and
in the adhering step, the porous layer and the separation layer adhere to each other by thermal fusion of the adhesive layer.

13. The method for producing a gas separation membrane according to claim 12, wherein
the separation layer forming step includes a treatment of forming the separation layer by forming a coating film containing the organopolysiloxane and irradiating the coating film with an electron beam or plasma.

14. The method for producing a gas separation membrane according to claim 12, wherein
the adhesive layer forming step includes a treatment of forming the adhesive layer by a vapor deposition method.
